(19) United States
(12) Patent Application Publication
(10) Pub. No.: US 2021/0055063 A1
(43) Pub. Date: Feb. 25, 2021

(54) SYSTEMS AND METHODS FOR PROVIDING HIGH TEMPERATURE AND HIGH PRESSURE HEAT EXCHANGERS USING ADDITIVE MANUFACTURING

(71) Applicants: THE REGENTS OF THE UNIVERSITY OF CALIFORNIA, Oakland, CA (US); CARNEGIE MELLON UNIVERSITY, Pittsburgh, PA (US)

(72) Inventors: Vinod Narayanan, Davis, CA (US); Erfan Rasouli, Davis, CA (US); Anthony Rollett, Pittsburgh, PA (US); Samikshya Subedi, Pittsburgh, PA (US)

(73) Assignees: THE REGENTS OF THE UNIVERSITY OF CALIFORNIA, Oakland, CA (US); CARNEGIE MELLON UNIVERSITY, Pittsburgh, PA (US)

(21) Appl. No.: 17/018,026

(22) Filed: Sep. 11, 2020

Related U.S. Application Data
(63) Continuation of application No. PCT/US2019/023765, filed on Mar. 22, 2019.
(60) Provisional application No. 62/646,843, filed on Mar. 22, 2018.

(51) Int. Cl. F28F 3/08; B33Y 80/00; F28D 9/00

(52) U.S. Cl. CPC F28F 3/08; F28F 2275/06; F28D 9/00; B33Y 80/00

(57) ABSTRACT

An apparatus with a first pathway configured to circulate a first substance and a second pathway configured to circulate a second substance between a plurality of plates. The first pathway includes: a plurality of plates with a plurality of flow channels; a first inlet configured to receive the first substance and provide the first substance to the first plurality of flow channels; and a first outlet configured to receive the first substance from the first plurality of flow channels. The second pathway includes: a second inlet configured to receive the second substance; and a second outlet configured to output the second substance.

### CROSS-REFERENCE TO RELATED APPLICATIONS

This application claims priority to, and is a 35 U.S.C. § 111(a) continuation of, PCT international application number PCT/US2019/023765 filed on Mar. 22, 2019, incorporated herein by reference in its entirety, which claims priority to, and the benefit of, U.S. provisional patent application Ser. No. 62/646,843, filed Mar. 22, 2018, incorporated herein by reference in its entirety. Priority is claimed to each of the foregoing applications.

The above-referenced PCT international application was published as PCT International Publication No. WO 2020/033013 A2 on Feb. 13, 2020, which publication is incorporated herein by reference in its entirety.

### STATEMENT REGARDING FEDERALLY SPONSORED RESEARCH OR DEVELOPMENT

This invention was made with Government support under contract or grant No. N00014-16-1-2027 awarded by the Office of Naval Research, and contract or grant No. DE-FE0024064 awarded by the Department of Energy. The Government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The present disclosure generally related to heat exchangers and more specifically to high temperature and high pressure heat exchangers using additive manufacturing.

### 2. Background Discussion

Supercritical carbondioxide (sCO₂) Brayton cycle has gained attention due to its potential for high cycle efficiency at moderate turbine inlet temperatures (for example, between 450° C. and 700° C. This power cycle may be paired with various sources such as fossil, solar, nuclear, geothermal, and moderate- to high-quality waste heat streams.

For waste heat recovery power cycles, it is desirable to place an efficient heat exchanger in the waste heat stream (e.g., the exhaust of a gas turbine) and transfer heat into the sCO₂ stream. Such a heat exchanger may be the Primary Heat eXchanger (PHX) of the sCO₂ cycle, because it is at the high temperature end of the cycle.

Technical challenges abound, however. Traditional heat recuperators include finned tube heat exchangers with flue gas going through a finned section and liquid flowing through tubes. The flue gas side may include fins to increase the surface area for heat transfer on the side with the largest thermal resistance. While finned tube heat exchangers lend to compact designs with higher overall heat transfer coefficients, they are limited to heat conduction through the fins. A large number of tube passes are often required to enhance fin efficiency, increasing the pressure drop through the recuperator. Furthermore, traditional finned tube heat exchangers are also arranged in counter-flow configuration to the flue gas, limiting the effectiveness of heat exchange.

### BRIEF SUMMARY

Technologies relating to high temperature and high pressure heat exchangers using additive manufacturing are provided.

An example device, in some implementations, includes: a first pathway configured to circulate a first substance and a second pathway configured to circulate a second substance between a plurality of plates. The first pathway comprises: the plurality of plates (which comprise a plurality of flow channels); a first inlet configured to receive the first substance and provide the first substance to the first plurality of flow channels; and a first outlet configured to receive the first substance from the first plurality of flow channels. The second pathway comprises: a second inlet configured to receive the second substance; and second outlet configured to output the second substance.

The first substance, in some implementations, has a high pressure and a low temperature.

The plurality of flow channels, in some implementations, comprises a first plurality of structural members configured to couple sides of each of the plurality of flow channels.

The second substance, in some implementations, has a low pressure and a high temperature.

The second pathway, in some implementations, further comprises a second plurality of structural members configured to couple sides of each of the plurality of plates.

The first pathway and the second pathway, in some implementations, are formed via additive manufacturing, and wherein the first pathway and the second pathway are formed without braze or weld joints.

The second inlet and second outlet are, in some implementations, coupled to an exhaust system of a vehicle.

The first inlet and the first outlet are, in some implementations, configured to circulate supercritical carbon dioxide.

### BRIEF DESCRIPTION OF THE SEVERAL VIEWS OF THE DRAWING(S)

FIGS. 1A and 1B are diagrams illustrating an example primary heat exchanger and various features of the example primary heat exchanger in accordance with some implementations of the present disclosure.

FIGS. 2A and 2B are graphs illustrating correlations between a primary heat exchanger's length, hot side pressure drop, cold plate spacing, and hot side inlet temperature in accordance with some implementations of the present disclosure.

FIG. 3 is a diagram illustrating various mechanical features of an example cooling plate of a primary heat exchanger in accordance with some implementations of the present disclosure.

FIGS. 4A and 4B are diagrams illustrating example velocity magnitude contours in the mid-plane and along the centerline, respectively, in accordance with some implementations of the present disclosure.

FIGS. 5A and 5B are diagrams illustrating example designs of a primary heat exchanger, which could improve hot side heat transfer coefficient in accordance with some implementations of the present disclosure.

FIGS. 6A and 6B are diagrams illustrating an example additively manufacturing machine and example build plates showing laser melting of powder accordance with some implementations of the present disclosure.

FIG. 7 is a diagram illustrating an example metal printing process including design and fabrication stages in accordance with some implementations of the present disclosure.

FIGS. 8A, 8B, and 8C are diagrams illustrating various features of a primary heat exchanger made using additive manufacturing technologies in accordance with some implementations of the present disclosure.

FIGS. 9A, 9B, and 9C are diagrams illustrating various features of an example pressure and temperature test facility in accordance with some implementations of the present disclosure.

FIG. 10 is a diagram illustrating an example thermofluidic test facility in accordance with some implementations of the present disclosure.

FIG. 11 is a diagram illustrating an example heated channel open-air loop in accordance with some implementations of the present disclosure.

FIGS. 12A and 12B are graphs illustrating various results of static pressure tests performed at different temperatures on an example primary heat exchanger in accordance with some implementations of the present disclosure.

FIG. 13 is a graph illustrating comparisons of pressure drops against volumetric flow rate and friction factor against Reynolds number between experiment and laminar flow theory.

FIG. 14 is a graph illustrating correlations between PHX effectiveness and exchange heat variation with Cr in accordance with some implementations of the present disclosure.

The implementations disclosed herein are illustrated by way of example, and not by way of limitation, in the figures of the accompanying drawings. Like reference numerals refer to corresponding parts throughout the drawings.

### DETAILED DESCRIPTION

The present disclosure provides technologies relating to the design, fabrication and preliminary thermal-fluidic characterizations of Additively Manufactured (AM) Primary Heat eXchangers (PHX) with microscale features. These technologies may provide the following technical advantages. The disclosed PHX implementations may improve effectiveness, withstand high internal pressures, large pressure difference between two fluid streams, and low pressure drop across a waste heat stream, and provide reliability under thermal cycling. More specifically, the disclosed PHX implementations would provide at least the following technical advantageous.

First, the disclosed PHX designs allow for a near-counter flow between a sCO₂ stream and a flue gas stream. In contrast with a finned tube design, a plate-type design is used where each of the fins in the traditional finned tube heat exchanger becomes a “cold plate” through which sCO₂ may flow directly. The sCO₂ stream may flow through an array of microscale pin fins within each plate. A pin fin design may be implemented in the microscale regions to provide higher heat transfer rate and better flow distribution than those provided by parallel micro channels.

Second, super alloys may be used to provide greater mechanical strength, greater resistance to creep deformation and rupture, greater surface stability, and better resistance to corrosion. In some implementations, Inconel 718 (a nickel-chromium-based super alloy with 50-55% nickel, 17-21% chromium, 4.57-5.5% niobium, 2.80-3.30% molybdenum, and trace amount of other compounds) is used for fabricating the PHX. PHXs fabricated with these or similar materials may provide not only high strength (tensile strength exceeding 1.4 GPa), but also high corrosion and oxidation resistant, and can operate within a wide temperature range, for example, between −423° F. and 1300° F.

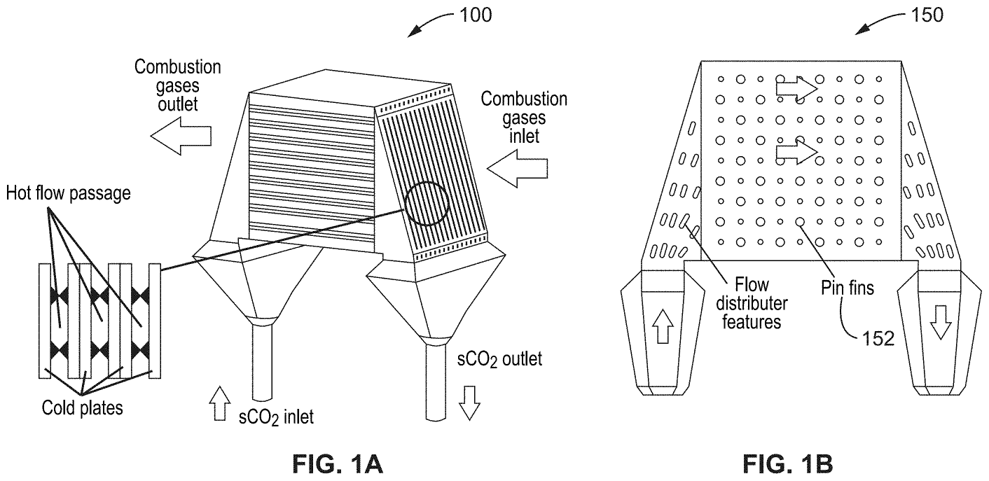

FIGS. 1A and 1B are diagrams 100 and 150 illustrating an example primary heat exchanger and various features of the example primary heat exchanger in accordance with some implementations of the present disclosure.

As shown FIG. 1A, an example PHX may include several cold plates (which may also be referred to as splates) that are spaced at a predefined distance apart from each other and connected to distributer and collector sCO₂ manifolds.

The several cold plates may be placed in a stream of hot combustion gases. The cold plates may include micro-pin fin plates 152, through which sCO₂ gas may flow in a near-counter flow direction to hot gases. To improve heat transfer coefficient on the hot side, fin structures are designed on the outer surface of the cold plates such that a cold plate is connected to its one or more adjacent cold plates.

Within each cold plate microchannel, as shown in FIG. 1B, two types of micro structures may be constructed to mechanically hold the internal channel together against high system pressure (e.g., 200 bar). Moreover, the micro structures on the inlet and outlet triangular plenums of a cold plate are designed in such a way that a gas flow is distributed uniformly along the width of the cold plate. Constructing micro pin fins along the length of a cold plate is technically advantageous, because it can enhance heat transfer and influence subsequent sCO₂ pressure drop.

The size of an PHX may be determined based on one or more of the following factors: the cross section dimensions of the duct carrying hot gases, the cold plates spacing, the fin spacing, the geometry design of cold plate pin fins, the temperatures at hot and cold flow inlets, the heat load capacity, and the material of which an PHX is made.

In some implementations, a PHX may include a square duct having cross section dimensions of 0.635 m×0.635 m (24×24 in²) for carrying hot gases. The PHX may be made out of Inconel 718 with effectiveness of 0.9 and has sCO₂ inlet temperature T_{(c,i)} and pressure at 250° C. and 200 bar, respectively. The fin spacing may be identical to the cold plate spacing. The cold plate may include a micro-gap with 500 um channel height without micro-pin fins on the microchannel plate. Using pin array correlations on the cold side may not change the efficiency of a PHX, because greater resistance to heat transfer often occurs on the hot side of the PHX. The hot gas inlet temperature T_{(h,i)} may be set to 800° C.; and sCO₂ outlet temperature T_{(c,o)} at 700° C. A PHX designed in accordance with the above-mentioned parameters may produce a heat load of approximately 2 MW.

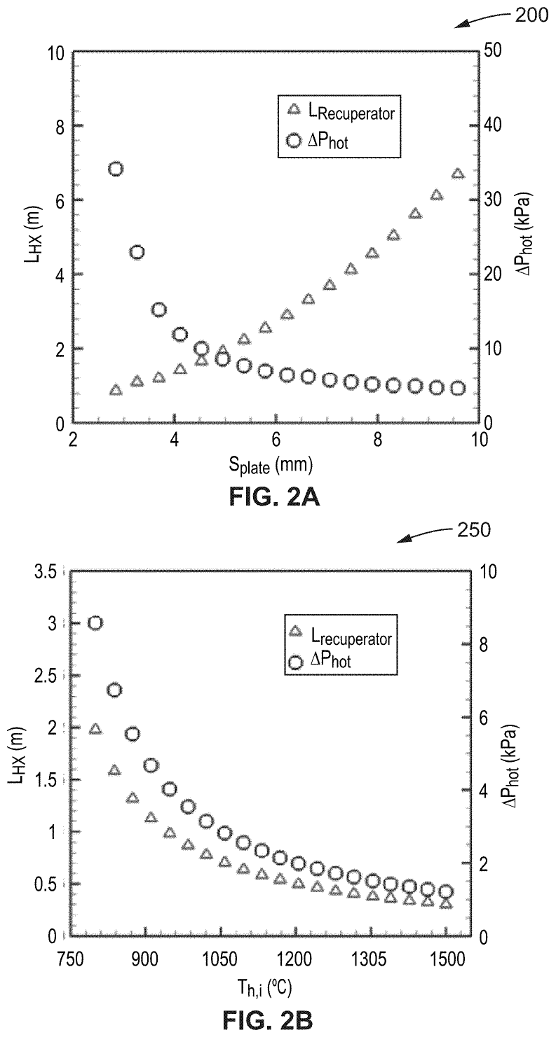

In some implementations, as shown in FIG. 2A, a PHX with smaller plate spacing may have a larger number of plates for a given duct size. To attain to the required heat transfer surface area, the length of the cold plates may be shorter. Reducing plate spacing increases the pressure drop, because the size of the hot flow passages decreases. In some implementations where the plate spacing is set to 2.8 mm and the length of the PHX is set to 0.86 m, the pressure drop may be less than 0.35 bar (−34.1 kPa), as shown in FIG. 2A.

Correlations between the length of a PHX and the hot side pressure drop T_{(h,i)} of the PHX are illustrated in FIG. 2B. Kept constant were the HX heat load at 2 MW, fin and plate spacing at 5 mm, and T_{(c,o)} at 700° C. In some implementations, T_{(c,o)} may be maintained constant at 700° C. by reducing the mass flow rate on the hot side, while increasing T_{(h,i)}. Increasing the hot side inlet temperature may significantly reduce the length of the PHX and result in a lower pressure drop. This is caused by reducing flow rate at higher inlet temperature to maintain a fixed rating of the PHX.

In some implementations, a PHX made using AM fabrication may be fitted in a duct with cross section of 5×5 cm2. In some implementations, such a scaled PHX may have a minimum wall thickness 500 um and the over-hanged features with respect to AM fabrication direction (the 90° angles) were replaced by moderate angles (e.g., angles that are smaller than 45°).

In some implementations, a PHX may be manufactured to withstand 200 bar internal pressure, while still maintaining a uniformed flow distribution within its cold plates.

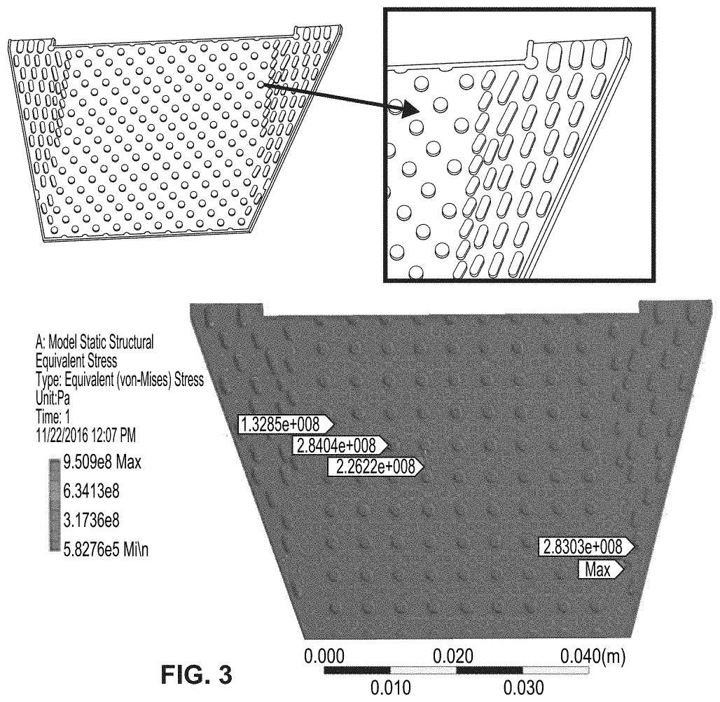

Mechanical integrity simulations using Ansys Mechanical APDL was performed on an example PHX; the results following several design iterations are shown in FIG. 3. The absolute pressure of 200 bar was imposed on all the internal surfaces of a cooling plate while the outer exposed surfaces were left at atmosphere pressure (1 bar). Due to the symmetry nature of the plate, only half of the plate was meshed. The tensile yield strength of Inconel 718 at 538° C. (1000° F.) is 1020 MPa. The mechanical simulations showed that the equivalent stress almost everywhere within the cooling plate were below 700 MPa. There are no cells in the side plenums with stresses higher than 500 MPa.

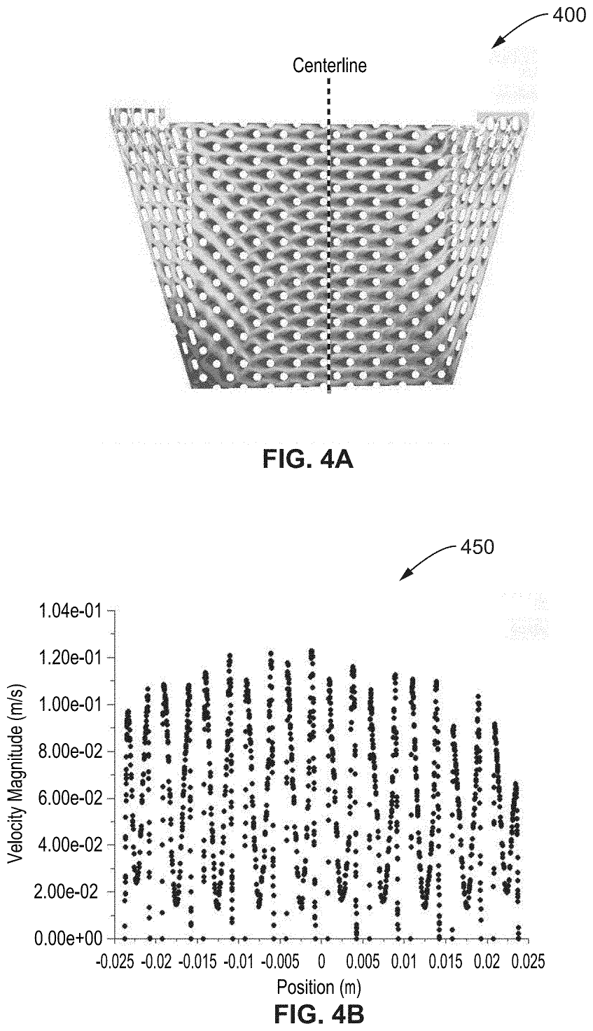

Upon verification of the structural aspects of the design, computational fluid dynamics (CFD) simulations were performed on the example PHX to ensure uniform flow distribution across the cooling plate. The velocity magnitude contours in the mid-plane between top and bottom walls are shown in FIG. 4A.

FIGS. 4A and 4B are diagrams illustrating example velocity magnitude contours in the mid-plane and along the centerline, respectively, in accordance with some implementations of the present disclosure.

The design inlet mass flowrate to each cooling plate is −0.11 g/s, which corresponds to 0.103 m/s inlet velocity, which was used as the boundary condition at the inlet. The pressure outlet boundary condition was used at the outlet of the plate while no-slip boundary condition was imposed to all other surfaces. The velocity magnitude along the centerline (marked in FIG. 4A) is shown in FIG. 4B which confirms acceptable flow uniformity.

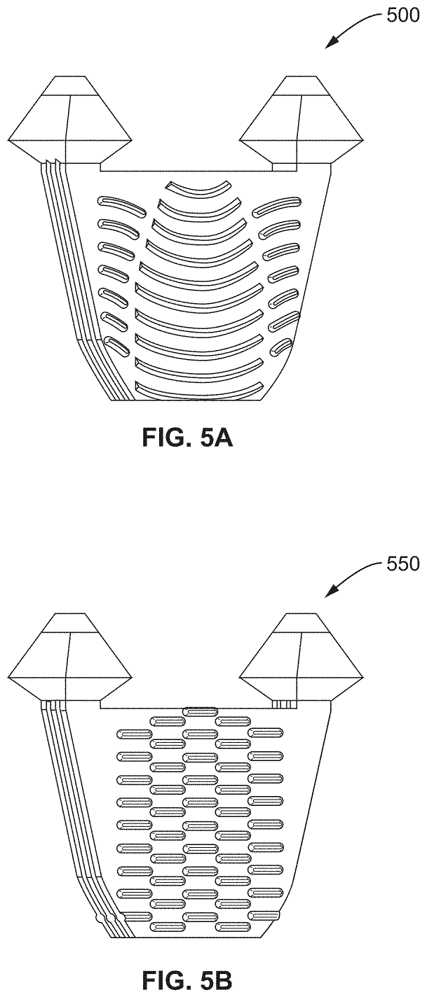

Mechanical design simulations were also performed on the inlet and exit plenums which connect all cooling plates together. In order to increase heat transfer on the hot side of HX, the external fin shapes were altered in two aspects: the first involved use of curved fins (shown FIG. 5A) and offset strip fins (shown FIG. 5B). The fin shape design iterations were performed for a sub-scale PHX which had only 3 cooling plates to reduce additively manufacturing fabrication time and cost. The offset fins may increase the development of flow region and enhance the hot side heat transfer. In addition to the increased surface area on the hot side, the curved fin design also serve to increase the length of counter flow based on the velocity stream lines of the cold stream (sCO₂) inside the cooling plates, as shown FIG. 5A. In some implementations, the designs of additively manufacture W PHX has 17 cooling plates and the sub-scale PHXs had 3 plates.

PHX Fabrication

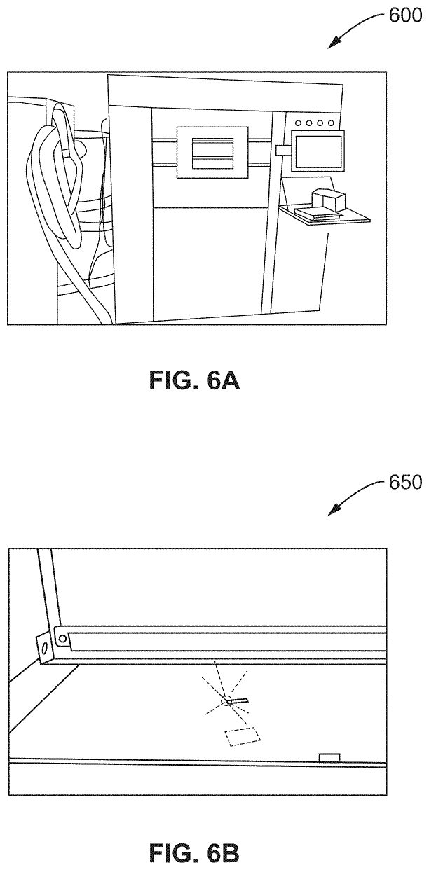

An example PHX fabrication machine (e.g., a Carnegie Mellon University EOS M190 AM machine) is shown in FIG. 6A, and using laser to melt powder particles on a build plate is shown in FIG. 6B. The re-coater arm may spread powder particles onto the build platform and any component thereon, from the right to the left. Up to 400 W fiber laser beam power may be used, for example, to ensure quality and precision. The build platform may move down, and the powder dispenser platform may move up after each successful layer spread and melting. Excess powder may then be collected in the hopper. The build platform may be heated to a low temperature during a fabrication process, for example, between 95° C. and 392° C. This powder spreading and melting process may be repeated a number of times, until a part is fully built.

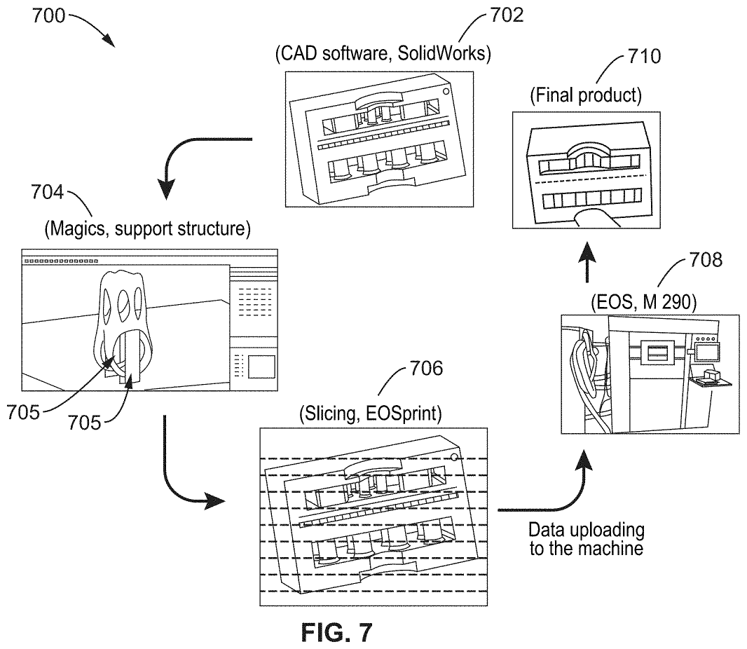

FIG. 7 is a diagram 700 illustrating an example metal printing process including design and fabrication stages in accordance with some implementations of the present disclosure.

In some implementations, a user may use a Computer Aided-Design (CAD) software application, e.g., a SolidWorks™ application, to create a design of a part to be manufactured. The design may then be saved in a computer file, which may then be converted to a predefined format for process by a second software application, For example, a design file may be saved in the .stl format and provided to a Magics™ application (704). A Magics™ application may add one or more support structures to the part under design; an example support structure is shown as 705. The Magics™ application may also check the contiguity of the part and provide feedback if there exists a dissembled or misaligned joint.

Next, the design file (including design of the support structure) may be provided to a 3D printing software application, e.g., an EOSprint software application (706), where the design is sliced into multiple layered designs, according to predefined layer thicknesses. Further, 3D printing parameters, such as power and velocity of a laser beam, pre- and post-contour beam settings, layer thickness, exposure and other parameters, may also be set. The resulting computer file is then executed on a 3D printing machine (e.g., an EOS machine) (708); a part may be printed to produce the final product (710).

Gas atomized powder provided or approved by EOS may be used in the fabrication process. In some implementations, the average powder particle size for Inconel 718 is 40 um. The powders used in an EOS machine are much finer than those used in an electron beam system and thus provide a higher resolution and a better surface finish than those provided by an electron beam system.

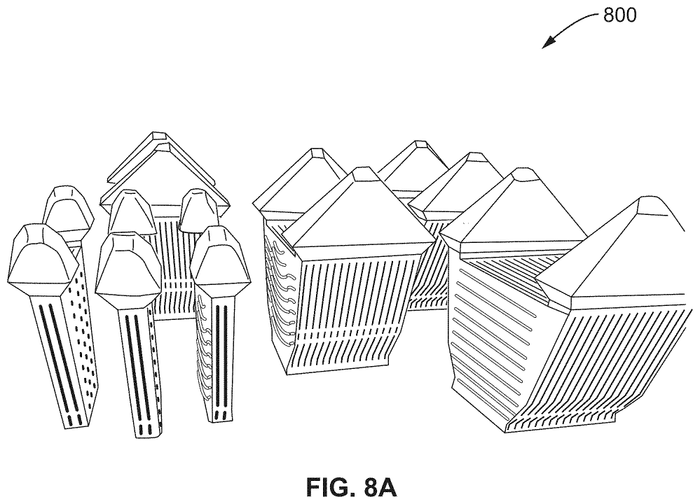

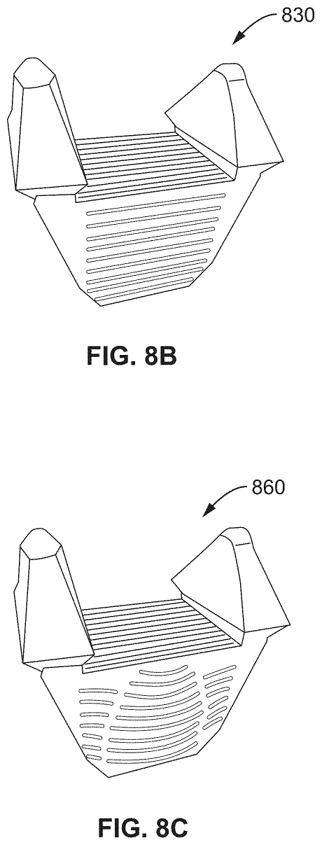

3-plate PHXs and 17-plate PHXs made using an additive manufacturing process are shown in FIG. 8A. An additively manufactured PHX may be subsequently heat-treated, as shown in FIG. 8B, as well as sand blasted to improve surface finish, as shown in FIG. 8C.

A PHX may then be flushed with fluid, both internally and externally, to remove excess powder. To remove powder lodged between the fins and the plates, additional cleaning may be needed, for example, immersing an additively manufactured PHX in an ultrasonic bath and an acetone bath. Due to the significant number of passages that may exist within a PHX, further cleaning may still be needed to remove excessive power and to unclog passages within the PHX.

Experimental Facility

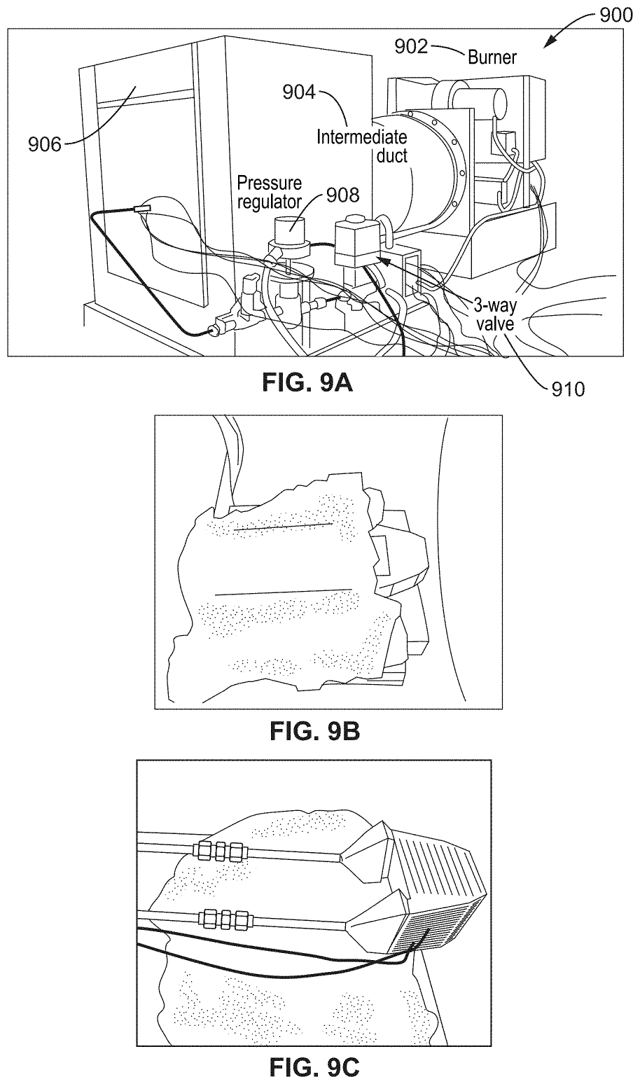

A Pressure & Temperature (P&T) test facility may be used to test the mechanical integrity of an additively manufactured PHX through static pressure testing at room temperature. As shown in FIG. 9A, an example P&T test facility may include a 500,000 BTU/hr natural gas burner 902, a steel P&T test chamber 906, and an 21-inch diameter quick-connect rigid steel duct 904 connecting the gas burner 902 and the test chamber 906. Both the duct 904 and the chamber 906 may be lined with high-temperature cellulose insulation.

Compressed nitrogen gas may be used to pressurize an additively manufactured PHX under test. For example, a 17-plate PHX may be placed on top of refractory firebricks inside the chamber 906 as shown FIGS. 9B and 9C.

Burner temperature may be measured using k-type thermocouples placed in-between the plates of a PHX. The temperature and line pressure may be recorded in a software application, e.g., a LABVIEW software application, at a rate of 4 Hz.

Thermofluidic Test Facility

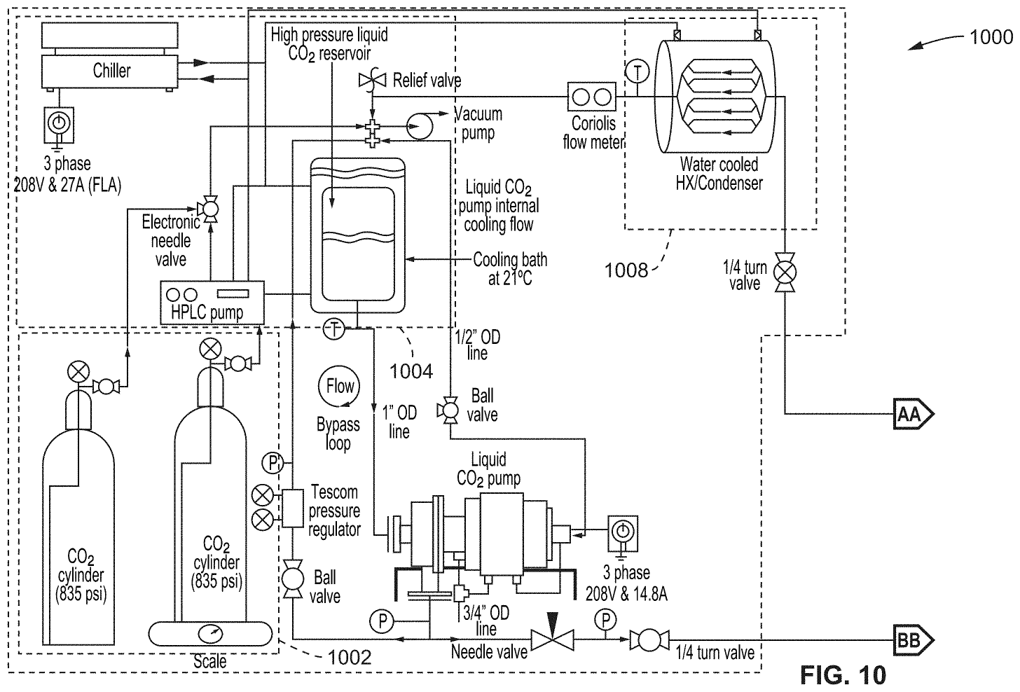

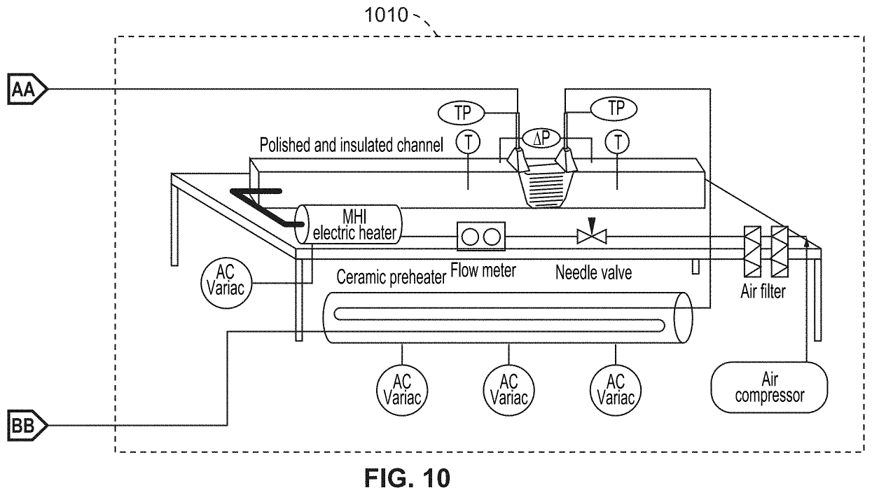

FIG. 10 is a diagram illustrating an example thermofluidic test facility 1000 in accordance with some implementations of the present disclosure.

The thermofluidic test facility 1000, as shown in FIG. 10, includes five major components: a gas charging section 1002, a pump and reservoir section 1004, a flow pre-heating section 1006, a heat rejection and condenser section 1008, and a heated air channel open-loop 1010.

Flow lines used to connect these components may be stainless steel 316 tubes with 0.75 inch and 0.25 inch outside diameter and predefined wall thickness. The materials form which these tubes are made and the sizes of these tubes may be selected to produce the required strength against 200 bar internal pressure (e.g., at temperatures up to 550° C.), while minimizing line pressure drop.

The gas charging section 1002 includes one or more cylinders of CO₂. A HPLC pump located in the pump and reservoir section 1004 is connected to the cylinders and used to raise the system pressure close to the target pressure of approximately 200 bar. Before charging, flow lines may be vacuumed using a vacuum pump to reduce contaminants and non-condensables that may be present. An electronically controlled three-way valve may be placed between the HPLC pump and the reservoir to charge the lines, provide closed loop operations, or release CO₂ from the flow lines.

CO₂ may be circulated through the loop using a two-stage high-pressure regenerative turbine pump (e.g., a Teikoku chempump). The two-stage high-pressure regenerative turbine pump may use working fluid to provide cooling for the turbo-machinery and thus require a reverse circulation plumbing set up for sCO₂. A high pressure accumulator may serve as a working fluid reservoir. The preheating section may be similar to the pressure and temperature test facility shown in FIG. 9. The outlet flow from the PHX may be cooled to approximately below 10° C. before it is returned to the liquid CO₂ pump using a 5-ton air-cooled chiller.

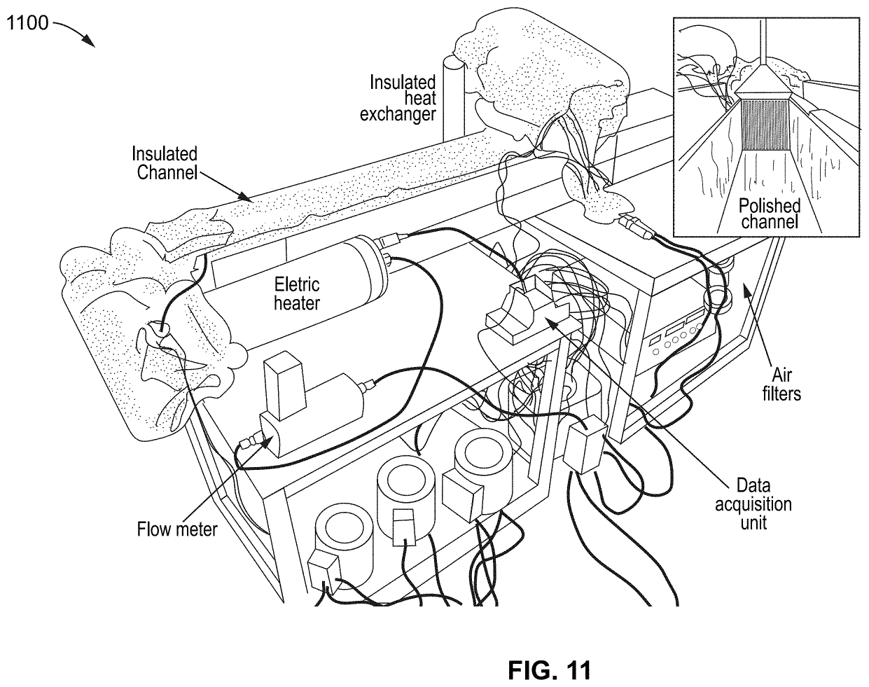

A PHX may be placed inside a 5 cm×5 cm stainless-steel channel insulated on the outside. Air may be supplied using a compressor. The air may be filtered, regulated, and metered to provide a desired flow rate of the hot side (shown in FIG. 11). An electric heater may heat the air before it is flown through the channel.

A 208V variac (variable autotransformer) may be used to increase the inlet temperature to −550° C. Temperatures may be recorded at the inlet and exit of the air stream as well as the CO₂ streams. The pressure drop on the heated air side may be measured using a high-accuracy pressure transducer (with uncertainty within ±0.05%, or 17.5 Pa). The air flow at the exit of the PHX may be exhausted to the ambient.

FIG. 11 is a diagram illustrating a heated channel open-air loop 1100 in accordance with some implementations of the present disclosure.

Example Results

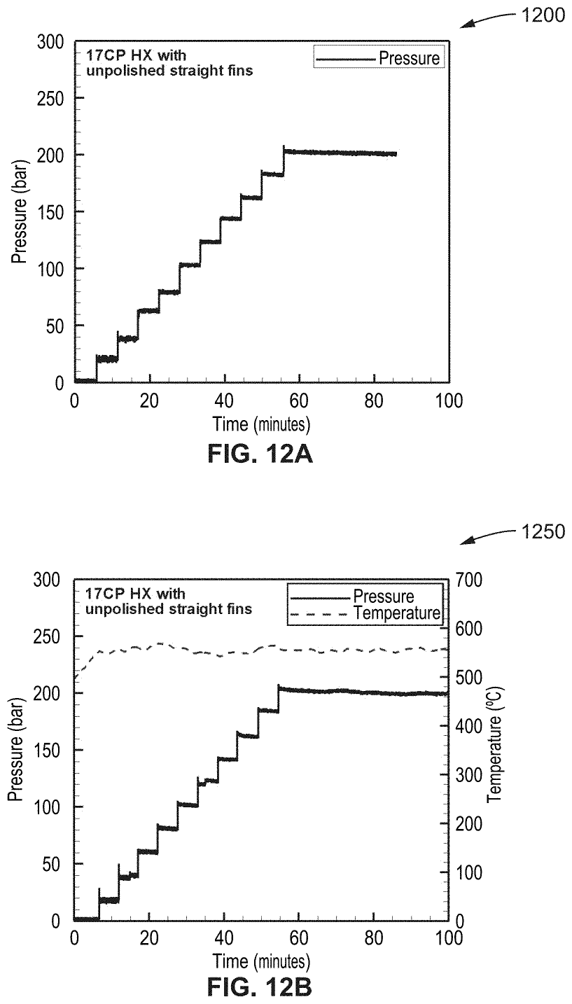

FIGS. 12A and 12B are graphs illustrating various results of static pressure tests performed at different temperatures on an example primary heat exchanger in accordance with some implementations of the present disclosure.

Shown in FIG. 12A are results of a static pressure test on a 17-plate PHX with straight fins on the hot side (the example PHX shown in FIG. 9C). The PHX was installed in the P&T facility shown in FIG. 9. One end of the PHX under test was capped, while the other end may be connected to a high pressure nitrogen source. The first test was performed at room temperature; its results are shown in FIG. 12A. As seen from FIG. 12A, the PHX was able to withstand an internal pressure of −200 bar.

Next, the pressure was released and the burner was turned on to bring the external temperature of the PHX to −550° C., the intended operating condition. The static pressure test was once again performed at this elevated temperature. Results from the high temperature test, shown in FIG. 12B, indicate that the PHX was structurally sound at those operating temperatures and pressure. The slight change in pressure at 200 bar between 60 and 80 minutes was caused by a leak in the fitting connecting the PHX to the regulator. This leak was rectified around the 80 minute timeframe beyond which the pressure remained stable.

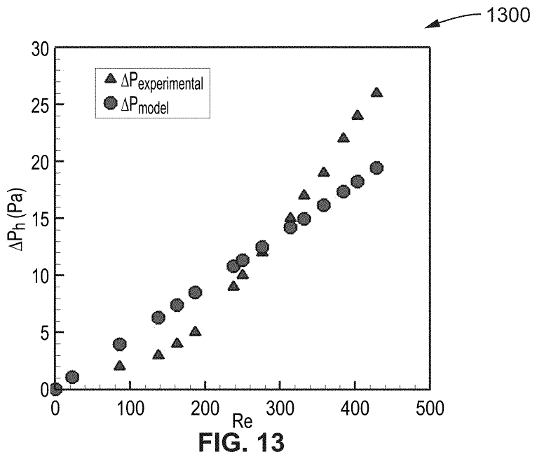

FIG. 13 is a graph illustrating comparisons 1300 of pressure drops against volumetric flow rate and friction factor against Reynolds number between experiment and laminar flow theory.

FIG. 13 shows the results of pressure drop measurements at a nominal temperature of 220° C. It should be noted that each flow rate resulted in a different average temperature, which was used to calculate fluid properties for the friction factor. Also shown in a comparison of laminar flow theory pressure drop and friction factor. The results indicate that at low flow rates, the experimental pressure drop is significantly larger than that predicted by the laminar flow theory.

The comparison is more favorable, however, when Re was greater than 200. It should be noted that the bias error in pressure drop measurement was 17.5 Pa; therefore, the error in the lower flow rates is considerable. Two potential causes for the differences are being explored (1) roughly 20 percent of the hot flow passages had residual powder that clogged the passages, and (b) the large surface roughness of the PHX. Passage blockage would also have resulted in decreased cross-sectional area for the flow, further increasing velocity and pressure drop through the passages.

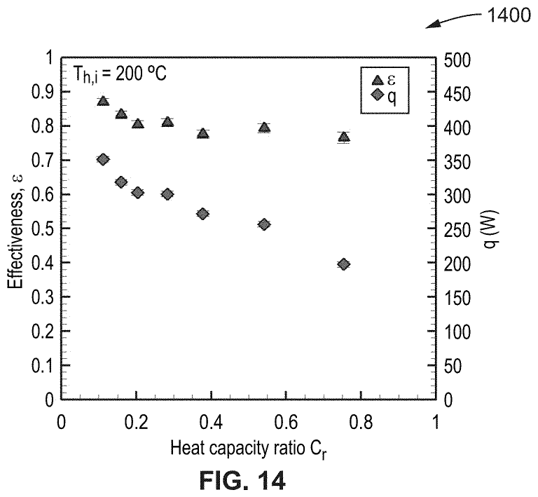

FIG. 14 is a graph illustrating correlations 1400 between PHX effectiveness and exchange heat variation with Cr in accordance with some implementations of the present disclosure.

Preliminary heat transfer experiments were performed with sub-critical CO₂ entering the PHX at saturation temperature and changing phase within the PHX. The temperature of the heated air was −200° C. Results of heat transfer effectiveness and NTU are shown in Table 1 (reproduced below). These estimates are based on the heat transferred from the hot side since the quality of the CO₂ at the exit was unknown. Accordingly, these effectiveness values are an upper bound and do not include heat loss.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first outlet could be termed a second outlet, and, similarly, a second outlet could be termed the first outlet, without changing the meaning of the description, so long as all occurrences of the “first outlet” are renamed consistently and all occurrences of the “second outlet” are renamed consistently. The first outlet and the second outlet are both outlets, but they are not the same outlet.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures, and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

TABLE 1
Preliminary Heat Transfer Results for the PHX
with Sub-Critical CO₂ Undergoing Phase Change

| \dot{m}ₐᵢᵣ | \dot{m}_{co2} | T_{air, in} | T_{air, out} | T_{co2, avg} | qₕ | | | UA | U |
|---|---|---|---|---|---|---|---|---|---|
| (kg/s) | (kg/s) | (C.) | (C.) | (C.) | (W) | ε | NTU | (W/K) | (W/m²-K) |
| 0.0017 | 0.0044 | 221 | 21.8 | 15.7 | 345 | 0.97 | 3.5 | 6.1 | 75 |
| 0.0017 | 0.0020 | 207.6 | 18.0 | 12.1 | 318 | 0.97 | 3.5 | 5.9 | 72 |
| 0.0035 | 0.0021 | 259.4 | 49.4 | 18.58 | 757 | 0.87 | 2.1 | 7.4 | 91 |

What is claimed is:

1. A device comprising:
(a) a first pathway configured to circulate a first substance, the first pathway comprising:
(i) a plurality of plates, wherein the plurality of plates comprise a plurality of flow channels;
(ii) a first inlet configured to receive the first substance and provide the first substance to the first plurality of flow channels; and
(iii) a first outlet configured to receive the first substance from the first plurality of flow channels;
(b) a second pathway configured to circulate a second substance between the plurality of plates, the second pathway comprising:
(i) a second inlet configured to receive the second substance; and
(ii) a second outlet configured to output the second substance.

2. The device of claim 1, wherein the first substance has a high pressure and a low temperature.

3. The device of claim 2, wherein the plurality of flow channels comprises a first plurality of structural members configured to couple sides of each of the plurality of flow channels.

4. The device of claim 1, wherein the second substance has a low pressure and a high temperature.

5. The device of claim 4, wherein the second pathway further comprises a second plurality of structural members configured to couple sides of each of the plurality of plates.

6. The device of claim 1, wherein the first pathway and the second pathway are formed via additive manufacturing, and wherein the first pathway and the second pathway are formed without braze or weld joints.

7. The device of claim 1, wherein the second inlet and second outlet are coupled to an exhaust system of a vehicle.

8. The device of claim 1, wherein the first inlet and the first outlet are configured to circulate supercritical carbon dioxide.
